(19) United States
(12) Patent Application Publication
(10) Pub. No.: US 2023/0257593 A1
(43) Pub. Date: Aug. 17, 2023

(54) AUTOMOTIVE FLUID TUBING WITH GRAPHENE INCORPORATED PAINT

(71) Applicant: Martinrea International US Inc., Auburn Hills, MI (US)

(72) Inventors: Anindya Banerji, Windsor (CA); Murali Chandrasekhar, Rochester, MI (US); Cory Doble, Ortonville, MI (US)

(21) Appl. No.: 18/110,584

(22) Filed: Feb. 16, 2023

Related U.S. Application Data
(60) Provisional application No. 63/311,111, filed on Feb. 17, 2022.

(51) Int. Cl. C09D 5/03; C09D 163/00; C09D 127/14; C09D 7/61

(52) U.S. Cl. CPC C09D 5/038; C09D 163/00; C09D 127/14; C09D 7/61

(57) ABSTRACT

A coated metal pipe for use as an automotive fluid transport tube, including a tubing formed into a circular cross sectional profile. An intermediate layer applied over said tubing. An outer paint topcoat incorporating a graphene-derivative applied over said intermediate layer providing superior corrosion resistance in addition to chemical and abrasion resistance.

### CROSS REFERENCE TO RELATED APPLICATION

The present application claims the priority of U.S. Ser. No. 63/311,111 filed Feb. 17, 2022.

### FIELD OF THE INVENTION

The present invention discloses an automotive fluid transport tube and a related method of manufacturing for providing superior corrosion/abrasion resistance. The tube can be constructed of any of a low carbon steel which may be nickel plated with welded single wall tubing, an extruded aluminum or a low carbon steel which may be copper plated with brazed double wall tubing. An intermediate layer can include any of a zinc/aluminum alloy, an electroplated zinc, an electroplated Zn/Ni or a hot dip aluminum. An uppermost topcoat consists of a water or organic solvent based paint with graphene dispersed in the paint.

The topcoat may include any of an epoxy paint, an epoxy ester paint or a poly vinyl difluoride paint. Graphene dispersed into the paint system may provide a percolation network for enhanced corrosion resistance as well as chemical and abrasion resistance when subjected to standard automotive testing conditions

### DESCRIPTION OF THE BACKGROUND ART

Fluid transport tubing in vehicles perform the critical function of carrying fuel, brake fluids and transmission oil coolants during vehicle operation. A transmission oil cooling (TOC) or a fuel filler tube includes a welded tube made from a low carbon steel and may be susceptible to corrosion which in turn would compromise safe operation of the vehicle.

To reduce vulnerability to corrosion, a Zinc-Aluminum alloy, electroplated Zinc, electroplated Zinc/Nickel or hot dip aluminum maybe applied directly on the steel tubing. For example, a Zinc layer or the electroplated Zinc acts as a sacrificial coating that in turn protects the steel tubing underneath. The top paint coating maybe an organic solvent based paint or a water based system which may some instances require a primer for adhesion to the underlying layer.

As is also known, graphene is a two-dimensional planar nanomaterial incorporating sp² bonded carbon atoms packed in the honeycomb lattice. Many of the material properties, such as high tensile strength, high chemical resistance, high thermal and electrical conductivity, that makes graphene lucrative stems from the unique bonding structure of the planar graphene. However, the application of graphene at a macroscopic scale for applications as in the automotive industry continues to be a challenge.

Given the above background description, U.S. Pat. No. 10,625,487, to Kerin, Jr. et al., teaches a coated metal pipe for use as an automotive fluid transport tube and including any of a single or double walled tubing formed into a circular cross sectional profile. An intermediate primer layer is applied over the tubing. A polyamide incorporating a graphene powder is further applied over the intermediate layer.

U.S. Pat. No. 9,810,350, to Crain, is directed to fuel system components having polymer compositions containing functionalized graphene sheets. In one embodiment, the fuel system can include a plurality of layers affixed to the fuel system component. The fuel system component is in direct contact with one or more fuels or provides one or more paths to ground from one or more second components that is in direct contact with flowing fuel. Each first layer can include any of a metal, fiber, and a woven material and each second layer can include a composition of one or more polymers and fully exfoliated single sheets of graphene having a carbon to oxygen molar ratio of at least 50:1.

CN 104789092A teaches an anticorrosive pant for hydraulic tubing and an associated preparation method. The paint includes each of a resin, a graphene water based dispersion liquid, a pigment filler, auxiliaries and a solvent.

CN 105969069A teaches a graphene-modified epoxy resin anti-corrosion coating including seventy to eighty parts by weight of a waterborne epoxy resin, four to seven parts of cumene hydro eroxide, ten to eighteen parts of graphene, 2.5 to 4.5 parts of hexamethylene diisocyanate biuret, 2.4 to 3.6 parts of ethylene diamine tetra acetic aciddisodium salt, 5 to 9 parts of methylbenzotriazole, 7 to 10 parts of nonylphenol polyoxyethylene ether. 5 to 8 parts of phytase, 4 to 6 parts of wax powder, 4 to 13 parts of polysulfone resin and 4 to 6 parts of copper sulfate. The graphene-modified epoxy resin anticorrosive coating has high abrasion resistance, high temperature resistance, water resistance and chemical corrosion resistance, bonding strength between the coating and a basal surface is strengthened, and the curing speed at any temperature is improved.

A further example of the prior art is shown by the automotive fluid tubing of Picco et al., U.S. Pat. No. 6,915,820 which is configured for carrying any of gasoline/diesel fuel or hydraulic fluid and is composed of a metal with a coating of aluminum, over which is extrusion coated a polyamide 12 layer and for improving the wear-resistance and corrosion-resistance of the tubing.

Berger et al., U.S. Pat. No. 9,556,358, teaches a method for coating of a metallic article, in which the metal surface is coated with a polymer or a two-component system that reacts to form a polymer following application to the metal surface. The composition includes a 70-2700 meq/kg olefinic double bonds which leads to stronger adhesion and to increased corrosion resistance.

US 2018/0119871, also to Kawai, teaches a coated metal pipe in which the multi-layered coating includes a chemical conversation layer and a primer layer which further includes a polyamide imide and at least one kind of additive component selected from a polyamide, a fluorine resin, a silane coupling agent, and an epoxy resin.

Other tubing systems are known in the art which utilize PVDF (polyvinylidene fluoride) paints and related water-based coatings, such providing a pure thermoplastic fluoropolymer that is non-reactive and possesses multiple coating benefits including resistance to solvents and acids, as well as possessing lower density as compared to similar fluoropolymers. On example is set forth in U.S. Pat. No. 6,500,565 to Usui which teaches a resin coating each of corrosion, weather and chemical resistance, durability and high heat resistance temperature. A steel tube optionally having a copper layer is formed. At that point, a zinc or zinc/nickel plating layer is formed on the outer circumferential surface of the steel tube, and a chromate film including a trivalent chromium compound is formed on the zinc or zinc/nickel plating layer. At least one layer of a kind of resin selected from the group consisting of polyvinyl fluoride, polyvinylidene fluoride (PVDF), polypropylene, polyethylene and polyamide resins is formed, as required, through a primer.

Finally, U.S. Pat. No. 6,589,617 to Hsich, teaches a coated metal tubing arrangement including each of a metal tube and an inner layer of a first polymeric material bonded to the tube to provide corrosion protection. The first polymeric material has a high crystallinity, a dampening factor of less than 0.05, and a flexural modulus of at least 100 MPa. An outer layer of a second polymeric material is extruded around the inner layer to absorb impact energies and to eliminate mechanical vibrations and acoustic noises. The second polymeric material has a dampening factor of at least 0.05 and a flexural modulus of less than 50 Mpa and includes a multi-phase polymer having at least one polymer component with a glass-transition temperature below room temperature.

### SUMMARY OF THE PRESENT INVENTION

The present invention is directed towards utilizing the superior material properties of graphene with suitable binders to generate a high quality paint as top coating for premium automotive industry scale fluid transport tubing. More particularly, the present invention discloses an automotive fluid transport tube and a related method of manufacturing for providing superior corrosion/abrasion resistance.

The tube can be constructed of any of a low carbon steel which may be nickel plated with a welded single wall tubing, an extruded aluminum or a low carbon steel which may be copper plated with brazed double wall tubing. An intermediate layer can include any of a zinc/aluminum alloy, an electroplated zinc, an electroplated zinc/nickel, or hot dip aluminum. An uppermost topcoat consists of a water or organic solvent based paint with graphene powder dispersed in the paint.

In a particular example, the topcoat maybe a solvent borne epoxy paint, or an epoxy ester paint or a polyvinyl difluoride paint dispersed with graphene-derivative. The graphene-derivatives may include but not limited to monolayer graphene, few layer graphene, graphene-oxide, reduced graphene-oxide, and functionalized graphene. The above-mentioned paint systems may be applied by either a spray, dip or a flow-coat application process onto the tubing followed by a curing process using a specific bake schedule. Graphene-derivatives dispersed into the paint system may provide a percolation network for the corrosive elements thus providing enhanced corrosion resistance.

In another particular example, the top coat may require an additional primer layer for adhering to the intermediate metallic layer on the tube. The primer maybe an inorganic-metal based sacrificial layer that further provides additional corrosion resistance to the coating layers underneath or it could be an epoxy-based primer for adhesion of the top coat. The primer may be applied by either a spray, dip or a flow-coat application process onto the tubing and may require additional curing process using a specific bake schedule. Graphene may also be dispersed into this primer layer to provide improved corrosion resistance.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a length cutaway illustration of a wall segment of an automotive fluid transport tube according to a first non-limiting embodiment and depicting a first layer of a low carbon steel which may be nickel plated with welded single wall tubing or may be a copper plated, with brazed double wall tubing with an intermediate zinc/aluminum alloy and an outer or topcoat of a paint mixed with graphene;

FIG. 1A is an end cutaway illustration of the automotive fluid transport tube of FIG. 1;

FIG. 2 is a length cutaway illustration of a wall segment of an automotive fluid transport tube according to a second non-limiting embodiment and depicting a first layer of a low carbon steel which may be nickel plated with welded single wall tubing or may be a copper plated, with brazed double wall tubing with an intermediate electroplated zinc and an outer or topcoat of a paint mixed with graphene;

FIG. 2A is an end cutaway illustration of the automotive fluid transport tube of FIG. 2;

FIG. 3 is a length cutaway illustration of a wall segment of an automotive fluid transport tube according to a third non-limiting embodiment and depicting a first layer of a low carbon steel which may be nickel plated with welded single wall tubing or may be a copper plated, with brazed double wall tubing with an intermediate hot dip aluminum and an outer or topcoat of a paint mixed with graphene;

FIG. 3A is an end cutaway illustration of the automotive fluid transport tube of FIG. 3;

FIG. 4 is a length cutaway illustration of a wall segment of an automotive fluid transport tube according to a fourth non-limiting embodiment and depicting a first layer of a low carbon steel which may be nickel plated with welded single wall tubing or may be a copper plated, with brazed double wall tubing with an intermediate electroplated zinc/nickel and an outer or topcoat of a paint mixed with graphene;

FIG. 4A is an end cutaway illustration of the automotive fluid transport tube of FIG. 4;

FIG. 5 is a length cutaway illustration of a wall segment of an automotive fluid transport tube according to a fifth non-limiting embodiment and depicting a base layer of an extruded aluminum and an outer or topcoat of a paint mixed with graphene; and

FIG. 5A is an end cutaway illustration of the automotive fluid transport tube of FIG. 5;

### DETAILED DESCRIPTION OF THE PREFERRED EMBODIMENTS

With non-limiting reference to the attached drawings the present invention teaches an automotive fluid transport tube of varying compositions, each of which being coated with a corrosion, abrasion and impact-resistant multi-layer or mono-coating system. The present invention also teaches a related method of manufacturing any tube covered under the present system, article or assembly.

In each variant disclosed, the tubing includes any of a low carbon steel which may be nickel plated with welded single wall tubing, an extruded aluminum or a low carbon steel which may be copper plated with brazed double wall tubing. An intermediate layer can include any of a zinc/aluminum alloy, an electroplated zinc, an electroplated zinc/nickel or a hot dip aluminum. An uppermost topcoat consists of a water or organic-solvent based paint with graphene powder dispersed in the paint.

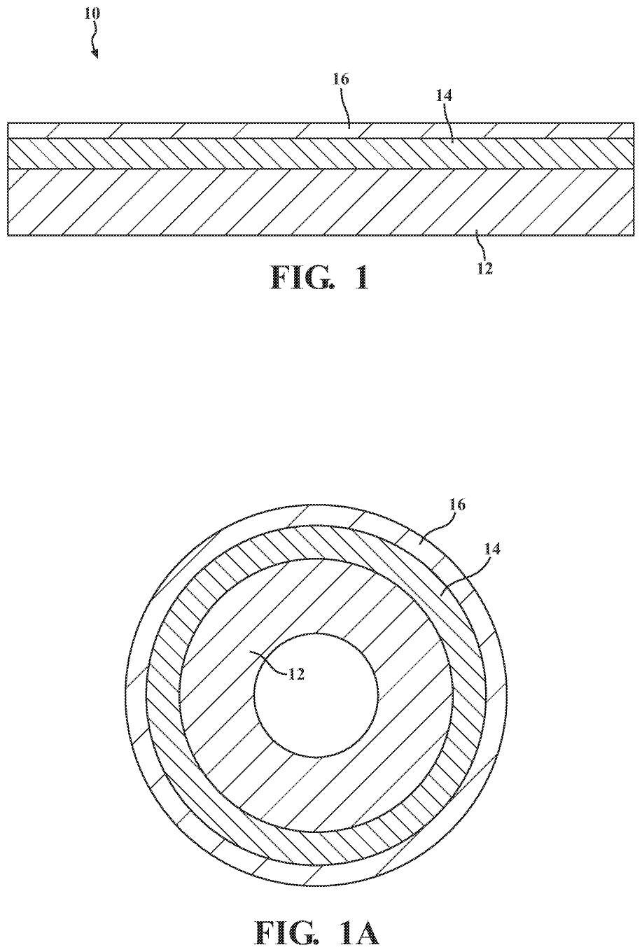

Referring initially to FIG. 1, a length cutaway illustration is generally shown at 10 of a wall segment of an automotive fluid transport tube according to a first non-limiting embodiment. As additionally shown in the end cutaway illustration of FIG. 1A, the tube depicts a first layer of a low carbon steel 12 which may be nickel plated with welded single wall tubing or may be coper plated brazed double walled tubing. Also depicted is an intermediate zinc/aluminum alloy 14 and an outer or top coat of a paint mixed with graphene, at 16.

As described herein the top coat may include an anticorrosive epoxy paint or an epoxy ester paint or a poly vinyl difluoride, with the graphene-derivative optionally being dispersed into the paint. By non-limiting example, a graphene-derivative powder dispersed into the paint system may provide a percolation network for enhanced barrier resistance.

It is also envisioned that the above-mentioned epoxy-based paint or polyvinyl difluoride based paint may be applied by a dip or spray or flow-coat application process onto the tubing followed by a curing process using a specific bake schedule. According to any of the application processes and methods employed, the use of any epoxy based paint or poly vinyl di fluoride based paint based top coat with dispersed graphene-derivative may exhibit superior corrosion resistance as well as chemical and abrasion resistance when subjected to standard automotive testing conditions.

It is also envisioned that the above-mentioned epoxy-based paint or polyvinyl di fluoride based paint may require an additional primer layer for improved adhesion of the paint top coat to the underlying intermediate metallic layer. The primer maybe an inorganic-metal based sacrificial layer that further provides additional corrosion resistance to the metallic tubing underneath or it could be an epoxy-based primer for adhesion of the top coat. The primer may be applied by either a spray, dip or a flow-coat application process onto the tubing, and may require additional curing process using a specific bake schedule. Graphene-derivative may also be dispersed into this primer layer to provide improved corrosion resistance.

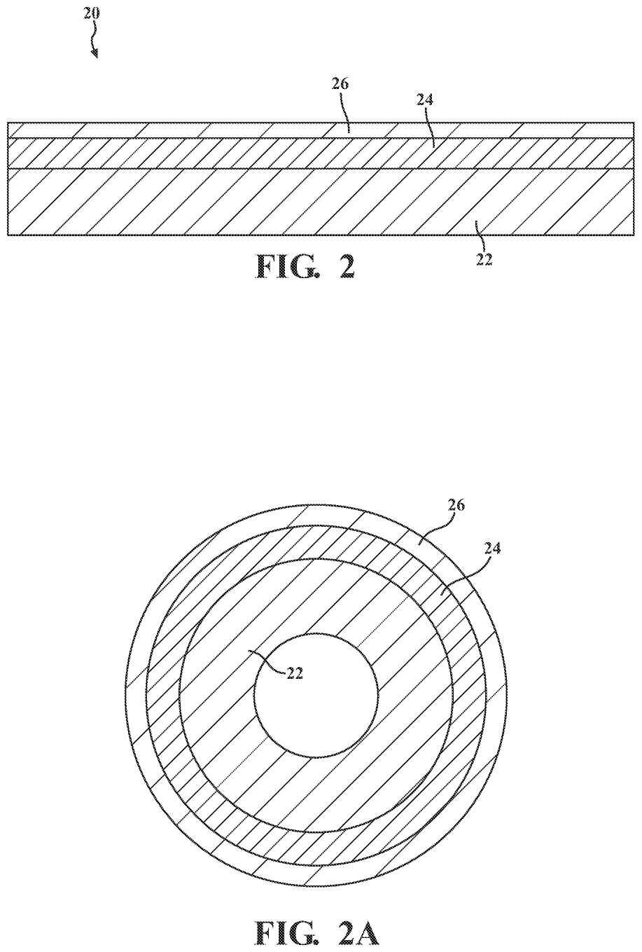

With reference to the length cutaway illustration of FIG. 2 and corresponding end cutaway illustration of FIG. 2A, a wall segment of an automotive fluid transport tube is generally shown at 20 according to a second non-limiting embodiment and depicting a first layer 22 of a low carbon steel which may be nickel plated with welded single wall tubing or may be a copper plated brazed double walled tubing, an intermediate layer 24 of an electroplated zinc and an outer or top coat 26 of a paint mixed with graphene, typically any type of graphene-derivative as previously described herein. The description of alternate graphene materials is repeated from the description of FIG. 1 for this and all other embodiments described herein.

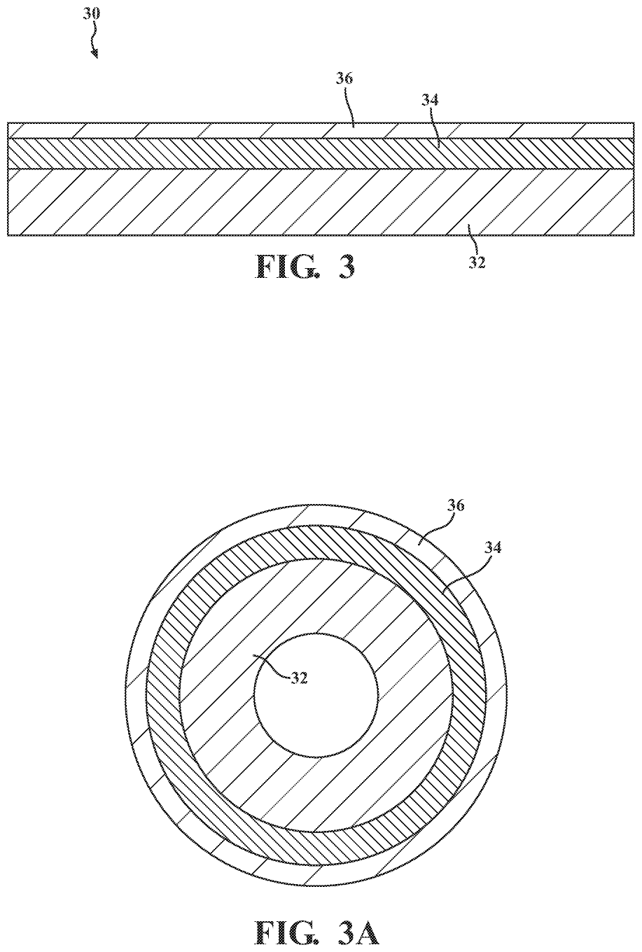

FIG. 3 is a length cutaway illustration of a wall segment of an automotive fluid transport tube, generally at 30, according to a third non-limiting embodiment and depicting a first layer of a low carbon steel 32 which may be nickel plated with welded single wall tubing or may be a copper plated brazed double walled tubing, over which is applied an intermediate layer of a hot dip aluminum 34 and an outer or top coat 36 of a paint mixed with graphene. FIG. 3A depicts an end cutaway illustration of the automotive fluid transport tube of FIG. 3.

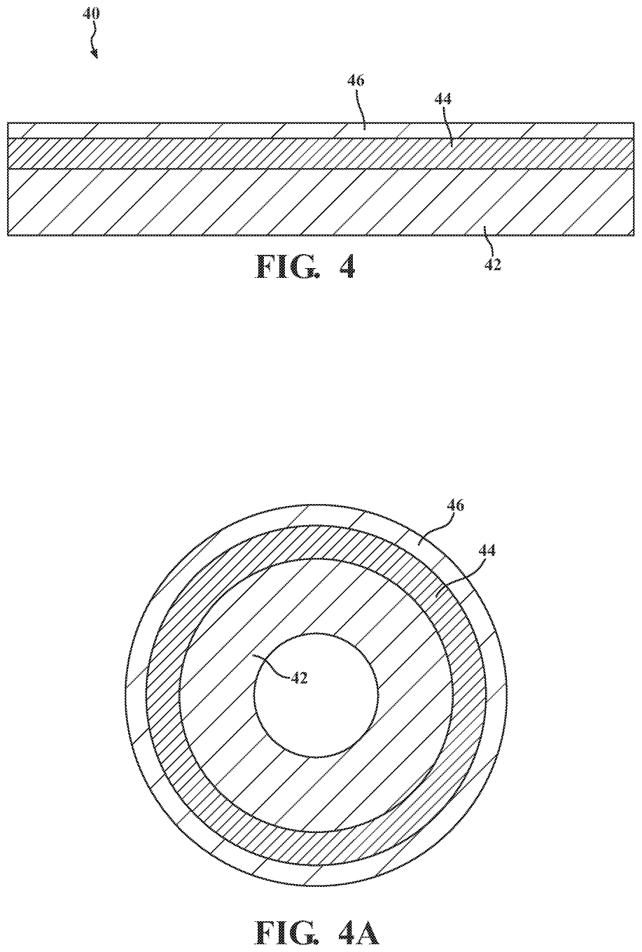

FIG. 4 is a length cutaway illustration of a wall segment of an automotive fluid transport tube, generally at 40, according to a fourth non-limiting embodiment and depicting a first layer of a low carbon steel 42 which may be nickel plated with welded single wall tubing or may be a copper plated brazed double walled tubing, over which is applied an intermediate layer 44 of an electroplated zinc/nickel and an outer or top coat 46 of a paint mixed with graphene. FIG. 4A depicts an end cutaway illustration of the automotive fluid transport tube 40 of FIG. 4.

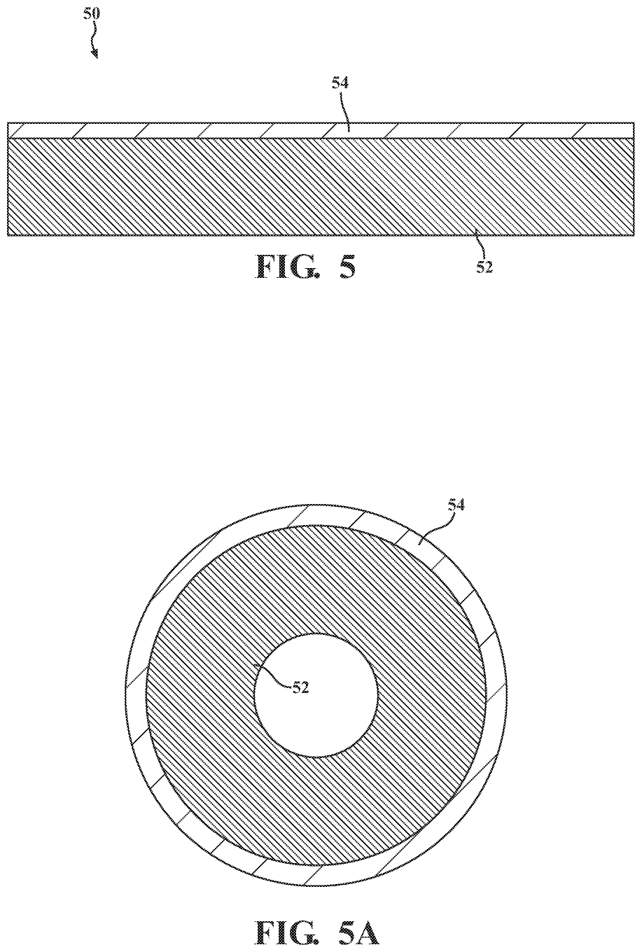

Proceeding to FIG. 5, provided is a length cutaway illustration, generally at 50, of a wall segment of an automotive fluid transport tube according to a fifth non-limiting embodiment and depicting a base layer 52 of an extruded aluminum and an outer or top coat 54 of a paint mixed with graphene. Finally, FIG. 5A presents an end cutaway illustration of the automotive fluid transport tube 50 of FIG. 5.

Having described my invention, other and additional preferred embodiments will become apparent to those skilled in the art to which it pertains, and without deviating from the scope of the appended claims. This can further include the tubing being constructed, without limitation, of any of a copper plated low carbon steel, low carbon steel, stainless steel, or aluminum. The present invention further contemplates other application processes outside of extrusion for applying the outer polymer layer(s) to the tubing.

Among related variants, this can include the use of any suitable forming process not limited to extrusion and including other injection molding techniques for forming the outer polyamide/graphene powder layer about the inner metal tube and desired combination of intermediate corrosion inhibiting layers.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

We claim:

1. A coated metal pipe for use as an automotive fluid transport tube, comprising:
a tubing formed into a circular cross sectional profile;
an intermediate layer applied over said tubing; and
an outer paint coat incorporating a graphene-derivative applied over said intermediate layer providing superior corrosion resistance in addition to chemical and abrasion resistance.

2. The coated metal pipe of claim 1, said tubing further comprising any of a low carbon steel or nickel or copper plated low carbon steel.

3. The coated metal pipe of claim 1, said intermediate layer further comprising any of a corrosion inhibiting zinc/aluminum alloy, electroplated zinc, electroplated zinc/nickel or hot dip aluminum applied directly over said tubing.

4. The coated metal pipe of claim 1, further comprising said graphene-derivative being intermixed as a powder with said outer paint coat.

5. The coated metal pipe of claim 1, said outer paint coat further comprising an anti-corrosive solvent borne epoxy paint, or an epoxy ester paint or a poly vinyl difluoride paint.

6. The coated metal pipe of claim 1, said outer paint coat further comprising a percolation network for providing enhanced barrier resistance.

7. The coated metal pipe of claim 1, said outer paint coat further comprising an water or solvent based paint system applied by either spray, flow or dip application type process onto said tubing followed by a curing process using a specific bake schedule.

8. The coated metal pipe of claim 1, said outer paint further comprising a primer layer underneath the top coat paint to improve adhesion, said primer layer including without limitation an inorganic metal-based or epoxy-based.

9. The coated metal pipe of claim 8, further comprising said graphene-derivative being intermixed as a powder with said primer layer.

10. The coated metal pipe of claim 8, said primer further comprising a percolation network for providing enhanced barrier resistance.

11. The coated metal pipe of claim 8, said primer further comprising of a water or solvent based primer system applied by either spray, flow or dip application type process onto said tubing may be followed by a curing process using a specific bake schedule.

12. A coated metal pipe for use as an automotive fluid transport tube, comprising:
an extruded aluminum tubing formed into a circular cross sectional profile; and
an outer paint coat with a graphene-derivative applied over said intermediate layer providing superior corrosion resistance in addition to chemical and abrasion resistance.

13. The coated metal pipe of claim 12, further comprising said graphene-derivative being intermixed as a powder with said outer paint coat.

14. The coated metal pipe of claim 12, said outer paint coat further comprising an anti-corrosive aluminum rich epoxy paint or an epoxy ester paint or a poly vinyl di fluoride paint.

15. The coated metal pipe of claim 12, said outer paint coat further comprising a percolation network for providing enhanced barrier resistance.

16. The coated metal pipe of claim 12, said outer paint coat further comprising any of an epoxy, an epoxy ester-based paint, or a poly vinyl difluoride system applied which is applied by any of a spray, flow or dip application type process onto said tubing followed by a curing process using a specific bake schedule.

17. The coated metal pipe of claim 12, said outer paint coat further comprising an underneath primer layer to improve adhesion, said primer layer including, without restriction, not limited to an inorganic metal-based or epoxy-based.

18. The coated metal pipe of claim 17, said underneath primer layer further comprising either of a water or solvent based primer system which is applied by any of spray, flow or dip application type processes onto said tubing, following which a curing process of said tubing occurs according to a specific bake schedule.

19. The coated metal pipe of claim 17, further comprising said graphene-derivative being intermixed as a powder with said primer layer.

20. The coated metal pipe of claim 17, said primer layer further comprising a percolation network for providing enhanced barrier resistance.
